(19) United States
(12) Patent Application Publication
(10) Pub. No.: US 2009/0026406 A1
(43) Pub. Date: Jan. 29, 2009

(54) CASING FOR A VENTILATING AND EVACUATING VALVE FOR PIPE LINES AND/OR FITTINGS

(75) Inventor: Helmut Grassl, Traunstein (DE)

Correspondence Address: RATNERPRESTIA, P.O. BOX 980, VALLEY FORGE, PA, 19482, US

(73) Assignee: HAWLE Armaturen GmbH, Freilassing (DE)

(21) Appl. No.: 12/178,147

(22) Filed: Jul. 23, 2008

(30) Foreign Application Priority Data
Jul. 24, 2007 (DE) 10 2007 034 312.6

(51) Int. Cl. F16K 27/00

(52) U.S. Cl. 251/366

(57) ABSTRACT

A casing for a ventilating and evacuating valve for pipe lines and/or fittings is provided. The casing comprises a hollow body, a connecting section and a ventilating and evacuating section. At least the hollow body of the casing is formed substantially of aluminium.

### FIELD OF THE INVENTION

The invention relates to a casing for a ventilating and evacuating valve for pipe lines and/or fittings.

### BACKGROUND OF THE INVENTION

Such ventilating and evacuating valves are used to ventilate and/or evacuate medium-guiding conduits, in particular pressurised conduits and specifically drinking water or sewerage conduits. They can be arranged at geodesic high points on the conduits themselves or on fittings in the conduction system. A conventional ventilating and evacuating valve is described for example in DE 10 2005 056 068 A1.

The casings of such ventilating and evacuating valves are usually spheroidal graphite casings, which therefore exhibit a very heavy weight, which makes transporting and handling them difficult. They also have to be elaborately protected against corrosion. There are ventilating and evacuating valves which comprise plastic casings, however these have the disadvantage that they can only be used in low pressure ranges; also, problems arise from the ageing effects of such plastic materials.

### SUMMARY OF THE INVENTION

One aspect of the present invention provides a casing for a ventilating and evacuating valve for pipe lines and/or fittings which at least partly overcomes the aforementioned disadvantages. In particular, the intention is to provide a light-weight and/or long-lasting casing which can also specifically be operated at higher pressures.

A casing in accordance with the invention for a ventilating and evacuating valve for pipe lines and/or fittings has a hollow body, a connecting section and a ventilating and evacuating section, and at least the hollow body of the casing consists substantially of aluminium. In other words, in accordance with the present invention, at least the largest and heaviest part of the casing is formed from aluminium, a material which is both able to withstand high pressures and exhibits a relatively low weight. In this way, the ventilating and evacuating valve as a whole is light-weight, but remains resistant to pressure. Another advantage of the choice of material in accordance with the invention is that the problems of material ageing and/or of an additionally required anti-corrosion layer no longer arise, since the aluminium material is itself resistant to corrosion and stable in its ageing.

It may be noted in very general terms that, when the terms “connecting section” and “ventilating and evacuating section” are mentioned here, these are intended to mean casing parts which are assigned to the respective corresponding functional elements of such a valve and/or which substantially enclose them or blank them off together with the casing. In most cases, the elements of the valve which establish the connection to the pipe system or to a fitting are provided in the casing separately from the elements which fulfil the ventilating and evacuating function. In principle, however, said casing parts can also be provided as a single integral body. It is also possible for the connecting section and the ventilating and evacuating section to belong to a single section, i.e. to be combined, as long as the main body, i.e. the hollow body of the casing, consists substantially of aluminium.

Although all these possibilities exist in principle, one embodiment of the casing in accordance with the invention is designed in a number of parts, and the connecting section and/or the ventilating and evacuating section is provided as a separate casing part which can be connected to the hollow body. In this case, the casing thus comprises the hollow body, and separately another body, namely the connecting section and the ventilating and evacuating section, respectively. In one embodiment variant, these two sections can be formed as end sections which can be attached in the manner of a flange to two end faces of the hollow body.

In accordance with one embodiment variant, the hollow body is formed to be substantially cylindrical. The connecting section and/or the ventilating and evacuating section can be formed as covers, in particular round covers, for the end faces of the hollow body.

In accordance with the invention, it is possible to form reinforcing ribs on the hollow body, in particular longitudinal reinforcing ribs, and in this case, it is in turn possible to use these reinforcing ribs for connecting the casing elements. This is for example achieved by providing connecting elements, for connecting the hollow body to the connecting section and/or ventilating and evacuating section, on the end faces of the reinforcing ribs in the region of the end faces of the hollow body. On the other side, the connecting section and/or ventilating and evacuating section can comprise connecting elements on their respective peripheral region, which are attached or formed complementarily to the connecting elements of the reinforcing ribs of the hollow body. The connecting elements of the hollow body and the connecting elements of the two sections cited are then used to assemble the casing.

In one embodiment of the invention, the hollow body is an aluminium extruded profile, and the connecting section and/or ventilating and evacuating section can be formed as aluminium die-cast parts, in particular as aluminium die-cast covers.

The invention also relates to a ventilating and evacuating valve comprising a casing such as has been described in various embodiments above.

### BRIEF DESCRIPTION OF THE DRAWINGS

The invention is illustrated below in more detail on the basis of an example embodiment. It can include any of the features described here, individually and in any expedient combination. The enclosed drawings show:

FIG. 1 a casing in accordance with the invention, in an oblique exploded view; and

FIG. 2 the casing of FIG. 1, in its assembled state.

### DETAILED DESCRIPTION

In the figures, an embodiment of a casing in accordance with the invention for a ventilating and evacuating valve is indicated as a whole by the reference sign 1. It comprises a cylindrical hollow body 3 and two round covers, namely an upper round cover 2 and a lower round cover 4. The round cover 2 may be referred to as the “ventilating and evacuating section” of the casing, since this casing will surround the ventilating and evacuating elements of the valve in its upper region. The ventilating flow into and/or evacuating flow out of the casing 1 will thus pass through the passageway 8.

The lower casing cover 4 may be referred to as the “connecting section”, since it is at this point that the casing and therefore the ventilating and evacuating valve can be placed onto a pipe of a conduction system or onto a fitting, in order to be connected to said element. A flange connection, which is not however shown in the drawings, is suitable for this purpose.

The upper cover 2 could also be referred to as the “ventilating and evacuating cover”, and the lower cover 4 could also be referred to as the “connecting cover”.

The hollow body 3 is an aluminium extruded profile, and in the present embodiment, the covers 2 and 4 also consist of aluminium, namely aluminium die casting. This choice of material enables a high operational pressure to be realised in a high-stability casing, without the valve or the casing having to be too heavy. Problems of material ageing or material corrosion do not arise; in particular, an anti-corrosion layer can be incorporated. Resistance to corrosion is particularly important in such valves, which are in most cases installed in underground engineering.

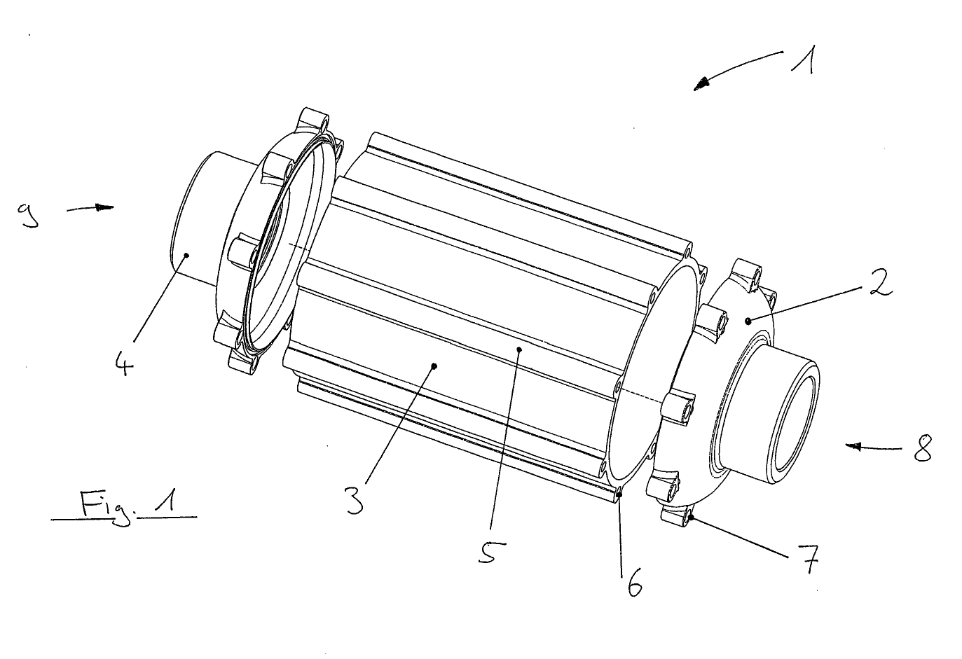

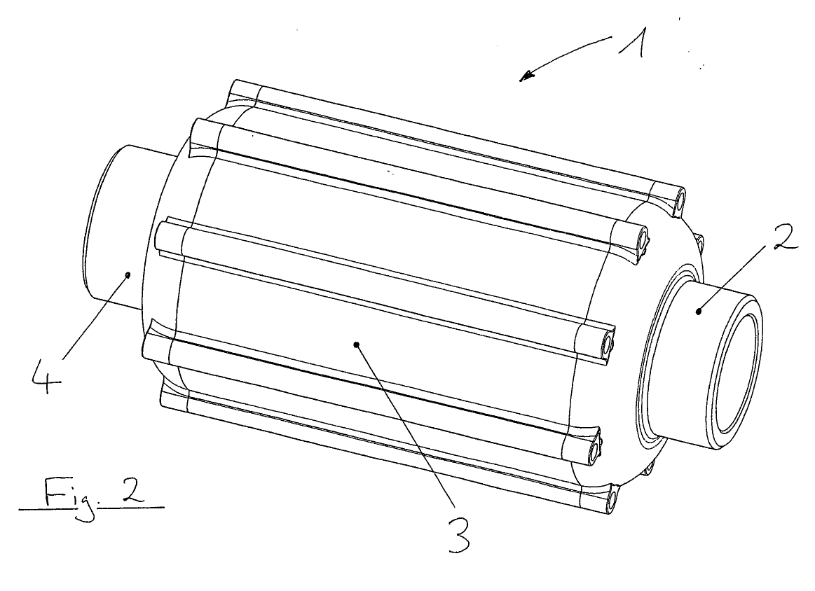

In the figures, it can be seen that the hollow body 3 comprises externally longitudinal ribs 5. These ribs have two advantages: on the one hand, they stabilise the hollow body and allow a thin wall thickness in the remaining regions of the hollow body; on the other hand, they provide the hollow body with a sufficient material thickness at particular points in order to securely attach the covers. The ribs 5 comprise connecting elements on their end faces, for example bores having an internal thread. Connecting elements, namely lug appendages 7, are in turn attached to the covers 2, 4, complementarily to the bores, which bear the reference sign 6 in FIG. 1, i.e. at corresponding circumferential points. In the example embodiment shown, the lug appendages 7 in turn comprise bores, namely through-bores, and the respective cover 2 and/or 4 can be attached to the hollow body 3 via these bores with the aid of bolts, such that an assembled valve casing is obtained, such as is shown in FIG. 2.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A casing for a ventilating and evacuating valve for pipe lines and/or fittings, wherein the casing comprises a hollow body, a connecting section and a ventilating and evacuating section, wherein at least the hollow body is comprised substantially of aluminium.

2. The casing according to claim 1, wherein it is designed in a number of parts, and the connecting section and/or the ventilating and evacuating section is provided as a separate casing part which can be connected to the hollow body.

3. The casing according to claim 1, wherein the connecting section and/or the ventilating and evacuating section are formed as end sections which can be attached in the manner of a flange to two end faces of the hollow body.

4. The casing according to claim 1, wherein the hollow body is formed to be substantially cylindrical.

5. The casing according to claim 1, wherein the connecting section and/or the ventilating and evacuating section are formed as covers, in particular round covers, for the end faces of the hollow body.

6. The casing according to claim 1, wherein reinforcing ribs, in particular longitudinal reinforcing ribs, are formed on the hollow body.

7. The casing according to claim 6, further comprising connecting elements, for connecting the hollow body to the connecting section and/or ventilating and evacuating section, on the end faces of the reinforcing ribs in the region of the end faces of the hollow body.

8. The casing according to claim 7, wherein the connecting section and/or ventilating and evacuating section comprise connecting elements on their peripheral region, which are attached or formed complementarily to the connecting elements of the reinforcing ribs of the hollow body.

9. The casing according claim 1, wherein the hollow body is an aluminium extruded profile.

10. The casing according to claim 1, wherein the connecting section and/or ventilating and evacuating section are formed as aluminium die-cast parts, in particular as aluminium die-cast covers.

11. A ventilating and evacuating valve comprising a casing according to claim 1.
